(19) United States
(12) Patent Application Publication
(10) Pub. No.: US 2014/0308648 A1
(43) Pub. Date: Oct. 16, 2014

(54) SYSTEM FOR QUESTION ANSWERING

(71) Applicant: Rishabh Jain, Champaign, IL (US)

(72) Inventor: Rishabh Jain, Champaign, IL (US)

(21) Appl. No.: 13/934,234

(22) Filed: Jul. 3, 2013

Related U.S. Application Data
(60) Provisional application No. 61/812,161, filed on Apr. 15, 2013.

(51) Int. Cl. G09B 7/00

(52) U.S. Cl. CPC G09B 7/00
USPC 434/362

(57) ABSTRACT

A system includes: a controller; a memory coupled to the controller, wherein the memory is configured to store program instructions executable by the controller; wherein in response to executing the program instructions, the controller is configured to: in response to receiving a request to generate an advisor list, wherein the request includes a topic area value, access a database including a plurality of advisor records, wherein each advisor record includes at least one topic area value, an advisor merit score value, and a recency of registration value; selecting advisor records for use in the advisor list, wherein the selected advisor records include at least three of the advisor records, including a first record selected based on advisor merit score values and a second record based on recency of registration values; and generate the advisor list using the selected advisor records.

### BACKGROUND OF THE INVENTION

The present subject matter relates generally to systems and methods for matching a user having a question to a user capable of answering the question. More specifically, the present invention relates to a system for enabling a user having a question to choose a user to answer the question from a list of users chosen by the systems and methods.

Question answering systems, such as question answering websites, are a popular and well-trafficked mechanism for users to solve problems in their lives. However, previous question answering websites suffer from many drawbacks. Particularly, some previous websites published questions to all members for answering. Generally, these websites allowed users to answer questions at any time at their discretion; thus, these websites could not guarantee a timely answer to a question. Additionally, publishing the questions to all users often resulted in a barrage of answers. Typically most of the answers were of low quality since those who are most suited to answer lacked an incentive to answer. Further, by publishing the questions to a large audience, previous websites discouraged users from asking important questions on important, but sensitive, subjects.

Accordingly, there is a need for a question answering system for answering a user's question that provides high quality answers, privacy, and provides incentives to ensure a timely answer, as described herein.

### BRIEF SUMMARY OF THE INVENTION

To meet the needs described above and others, the present disclosure provides a question answering system for answering a user's question that provides high quality answers, privacy, and provides incentives to ensure a timely answer by allowing a user, called a questioner, to choose another user, called an advisor, to answer a question for him or her from a list of users chosen by the system. The system is based on the principal that each of us is unique, due to various factors, such as, our birth, location, community, environment, education, language, knowledge, wisdom, experience, contacts, etc. The goal of the system for question answering is to harness each individual's unique experiences and knowledge to facilitate mutually beneficial information exchange by connecting people together over the internet using the systems described.

In an example embodiment, the user may select an advisor and any alternate advisors from a fixed size list of advisors called an advisor list. The advisor list is chosen from the pool of available advisors by the question answering system. The questioner may then submit a question to the question answering system for forwarding to the advisor for answering. As an incentive to encourage prompt answers, in some embodiments, the questioner may further be required to submit payment to be paid to the advisor after answering. The question answering system forwards the question to the chosen advisor. If the chosen advisor does not answer the question in a pre-determined time period, such as twenty-four hours, then the question answering system forwards the question to an alternate advisor, if any, for answering. If the alternate advisor also does not answer the question in the predetermined time limit, the question is forwarded to further alternate advisors until either the question is answered or the list of alternate advisors is exhausted. To answer a question, an advisor submits an answer to the question answering system for forwarding to the user. The question answering system may then forward the question to the user along with a prompt requesting feedback regarding the answer.

The advisor list is chosen by the question answering system to provide questioners with a list of advisors well suited to answer his or her question. The advisor list may be a short list of a fixed length. In a preferred embodiment, the advisor list may include five advisors to present the questioner with a manageable list of advisors to choose from. In alternative embodiments, the advisor list may be other lengths, for example, the advisor list may include ten advisors. The advisor list may be any length that provides a manageable selection of advisors that includes a sufficient number of advisors to provide variety for the questioner to choose from, as will be appreciated by those skilled in the art from the examples provided herein.

To provide a well-suited list of advisors, the advisor list may be drawn from the pool of available advisors based on a variety of factors that indicate likelihood of being able to answer the question competently and quickly while providing advisors a fair opportunity to be considered by questioners.

First, to choose advisors knowledgeable in the subject, one factor that may be used in assembling the advisor list is a topic category and/or sub-category. The user may select from a list of general categories and/or sub-categories or may be allowed to create their own category. The user may select multiple categories and/or sub-categories that the question pertains to. In an embodiment, the advisors in the system are listed as being knowledgeable in categories and sub-categories of their choosing, and advisors not listed in the categories and/or sub-categories chosen may be excluded from the advisor list for the question.

To encourage better answers, a further factor that may be used in assembling the advisor list is advisor feedback. Advisor feedback may be received from questioners. In an embodiment, after receiving an answer to a question, a questioner may be presented with an opportunity to provide feedback by rating the answer. Ratings for an advisor received from multiple questioners may be aggregated into a feedback score for the advisor. The feedback score may represents a ranking of the advisor relative to other advisors. The feedback score may take into account the total amount of feedback received to prevent advisors having only a few strong ratings from outranking advisors with a slightly lower average who have a long history of excellent ratings. For example, if the advisors are ranked on a ten point scale, an advisor having an average of 9.0 with 20 ratings from questioners may be given a higher feedback rating, all else equal, than an advisor having an average of 9.5 with only two ratings from questioners. In some embodiments, feedback may be multi-dimensional. For example, the question answering system may ask for feedback regarding the correctness of an answer, the level of useful detail in the answer, the user's satisfaction with the speed of the answer, etc. It is contemplated that feedback may include any appraisal of an advisor's activity in the question answering system, as will be understood by those skilled in the art from the examples provided herein.

An even further factor that may be used in determining a list of advisors may be the timeliness of providing an answer. A timeliness score may be calculated, such as the average time an advisor has taken to respond to a question presented to him or her. The timeliness score may also be a ranking or rating that ranks an advisor relative to all advisors based on an average time to respond to questions presented to them. A questioner may indicate a preference for increased timeliness for questions that are very time dependent, or may indicate a reduced or lack of preference when timeliness is not important.

An additional factor that may be used in determining an advisor list may be the duration of time the advisor has been registered to answer questions in the system. Since new advisors lack feedback, they lack a rating history capable of calculating an accurate feedback score. Thus, the question answering system may favor new advisors by preferentially including new users in the advisor list. For example, in a preferred embodiment, new advisors may be displayed in the first three positions of the advisor list as a trial period for the new advisor. During the trial period a new advisor may be preferentially included in advisor lists for a set number of times, for example, five times, to permit new advisors to develop a ranking and to encourage their participation in the system by being asked questions as soon as possible. In the preferred embodiment, after the trial, new advisors will be included in advisor lists as previously described.

The factors may be aggregated into an overall rating that may be used to select advisors for inclusion in the advisor list. In an embodiment, an overall rating may be used to compile the advisor list by choosing the advisors having the highest overall rating. In an alternative embodiment, the advisors may be chosen probabilistically from the pool of advisors in a manner that preferentially favors advisors having higher overall ratings.

Alternatively, the factors may be used to select advisors for inclusion in the advisor list on a quota basis. In an preferred embodiment, two of the advisors are selected on a random basis out of the most recent one hundred advisors to register, in the respective category; another two advisors are selected on a random basis out of the database of advisors pertaining to the respective category; and one advisor is selected from the top of the overall ratings maintained for each category.

An object of the invention is to provide a mechanism for questions to receive quality answers without requiring advisors to have professional or formal qualifications thus allowing advisors to highlight their unique knowledge.

A further object of the invention is to utilize the uniqueness of each individual, to give and serve society, by empowering them to give advice reflecting each person's individual knowledge and experience.

An additional objective of the invention is to permit individuals to give advice without being excluded by their educational qualifications and/or their experiences.

Yet another objective of the invention is to permit individuals to give advice in exchange for payment for the service provided.

An advantage of the invention is that it provides for timely answering of a user's questions.

Another advantage of the invention is that it provides a single answer to user's question having a higher likelihood of being correct relative to services providing numerous, lower quality answers.

A further advantage of the invention allows exchange between people of all ages, and is not limited to people of major age.

Yet another advantage of the invention is that it provides answers to questions on sensitive topics without publishing questions to large groups of users or the public.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic diagram illustrating an example question answering system of the present disclosure.

FIG. 2 is a flowchart illustrating an example of the steps taken by a user to ask a question or to answer a question using the question answering system of FIG. 1.

FIG. 3 is screenshot of a user interface of the question answering system of FIG. 1 showing a category selection screen for questioners.

FIG. 4 is a screenshot of a user interface of the question answering system of FIG. 1 showing an advisor selection screen for questioners.

FIG. 5 is an example table of a database of the question answering system of FIG. 1.

FIG. 6 is screen shot of a user interface of the question answering system of FIG. 1 showing an answer screen for questioners to receive an answer and provide feedback.

FIG. 7 is a screenshot of a user interface of the question answering system of FIG. 1 showing a screen prompting an advisor to input his or her areas of expertise.

FIG. 8 is a screenshot of a user interface showing a screen prompting an advisor to input subcategories of his or her areas of expertise.

FIG. 9 is a flowchart illustrating an example of a method performed by the question answering system of FIG. 1 to enable a user to ask a question and receive an answer.

### DETAILED DESCRIPTION OF THE INVENTION

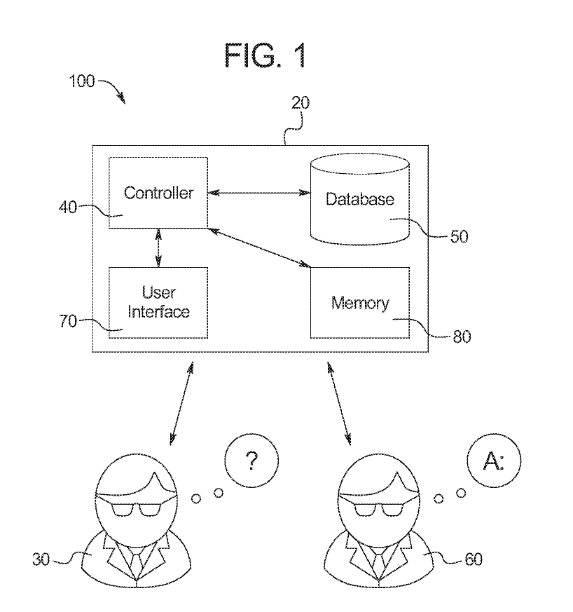

FIG. 1 illustrates an example of a question answering system 100 through which a questioner 30 may select an advisor 60 to answer his or her question from a list of advisors 60 compiled by the question answering system 100 from a database 50. In the example shown in FIG. 1, the question answering system 100 includes a question answering platform 20 including: a controller 40 adapted to compile a list of advisors 60, receive a selection of an advisor 60 or advisors 60, and mediate the asking and answering of a question; a database 50; and a user interface 70. The user interface 70 provides one or more screens through which questioner 30 and advisors 60 may interact with the question answering system 100.

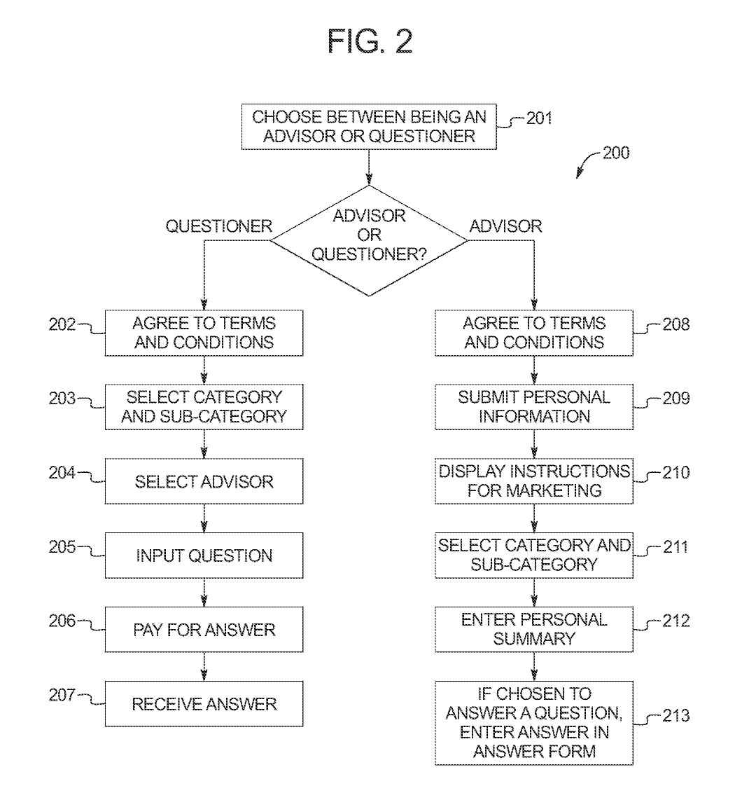

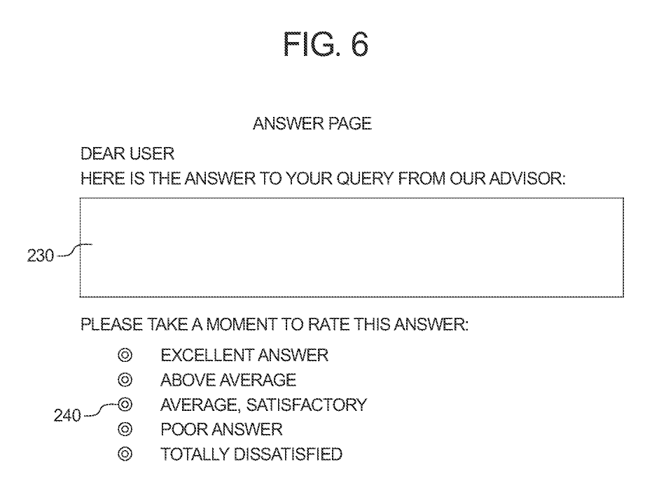

FIG. 2 is a flowchart showing the method 200 of operation as perceived by a user to ask a question or to answer a question using the question answering system 100. As shown in FIG. 12 at step 200, when a user accesses the question answering system 100 he or she may choose whether he or she wants to be a questioner 30 and ask a question, or as to whether he or she wants to answer questions and become an advisor 60. If the user chooses to ask a question (hereinafter ‘questioner 30’), the questioner 30 is then directed to a series of screens to perform the steps 200-207 of asking a question, receiving an answer 230, and providing feedback 240 (FIG. 6) using the question answering system 100. Alternatively, if the user chooses to be an advisor 60 (hereinafter ‘advisor 60’), the advisor 60 is then directed to a series of screens to perform the steps 208-213 of answering a question using the question answering system 100. A user may be both a questioner 30 and an advisor 60 for different questions, and in embodiments where the advisor 60 is paid for answering questions; the advisor 60 may apply any earnings towards payment for future questions.

As shown in step 202, the questioner 30 begins the process of asking a question by agreeing to the terms and conditions of the question answering system 100.

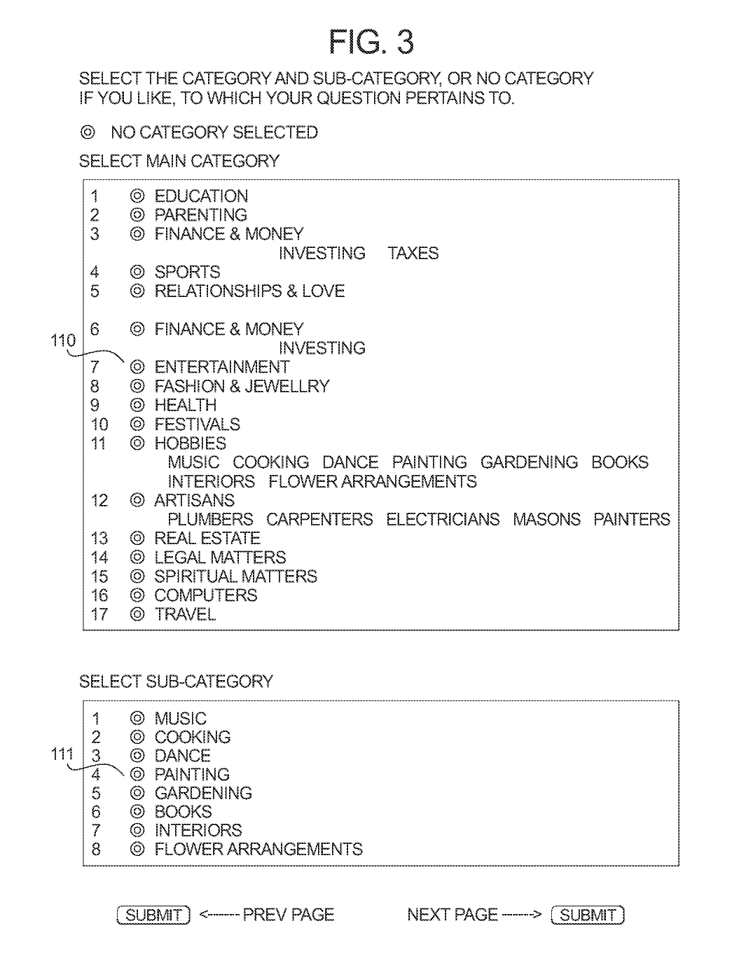

As shown in FIG. 3, at step 203, after agreeing to the terms and conditions, the questioner 30 may be prompted by a category selection screen to select a category 110 and/or subcategories 111 relating to the topic of the question. The questioner 30 may select from a list of general categories 110 or may be allowed to create their own category 110.

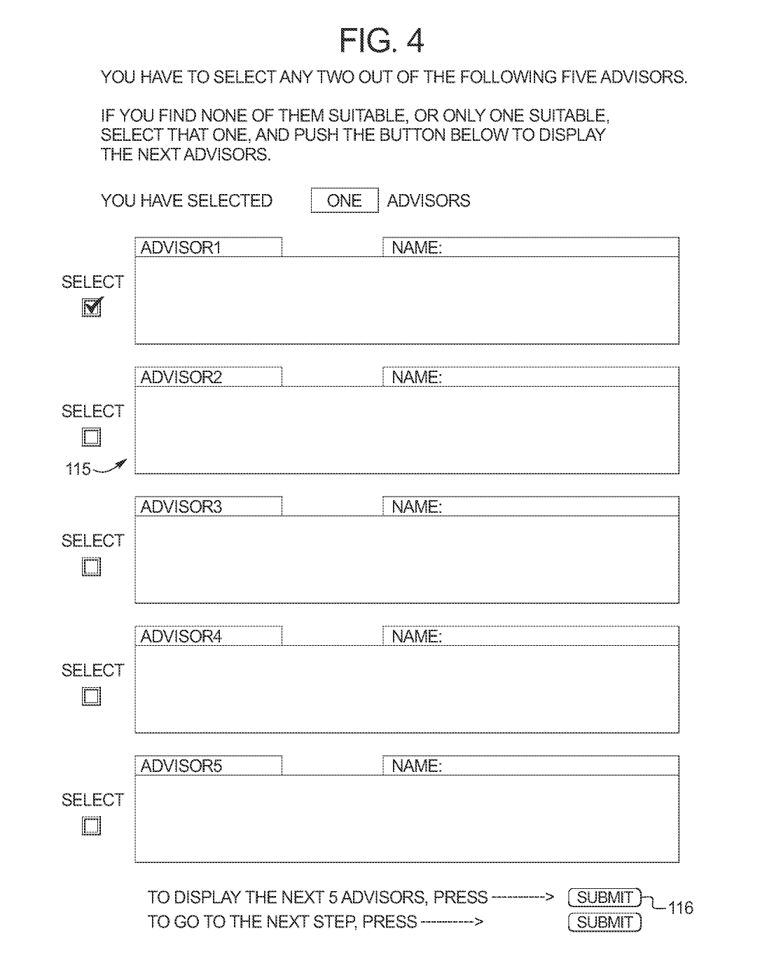

At step 204, as shown in FIG. 4, the questioner 30 is then presented with an advisor list 115 and may select from the advisor list 115 to choose an advisor 60 to answer his or her question. The advisor list 115 may have a fixed size regardless of category 110. In the embodiment shown, five advisors 60 are included in the advisor list 115. In alternative embodiments, the advisor list 115 may be other lengths, for example, the advisor list 115 may include ten advisors 60. The advisor list 115 may be any length that provides a manageable selection of advisors 60 that includes a sufficient number of advisors 60 to provide variety for the questioner 30 to choose from, as will be appreciated by those skilled in the art from the examples provided herein.

For each advisor 60 in the advisor list 115, a summary of that individual's skills, background, etc. may be displayed, so as to enable the questioner 30 to decide which of the advisors 60 to choose for answering their question. The questioner 30 may be permitted to select multiple advisors 60, such as a main advisor 60 and any alternate advisors 60 who may answer the question if the main advisor 60 fails to answer within a predetermined time. In a preferred embodiment, the questioner 30 chooses one advisor 60 and one alternate advisor 60. If the questioner 30 feels that the advisors 60 displayed are not adequate to answer their question, they may then select button 116 to proceed to a further list of advisors 60, and if again not satisfied, may continue to proceed through advisor lists 115 until a sufficient number of advisors 60 are chosen, as may be determined by the user or predetermined in the question answering system 100.

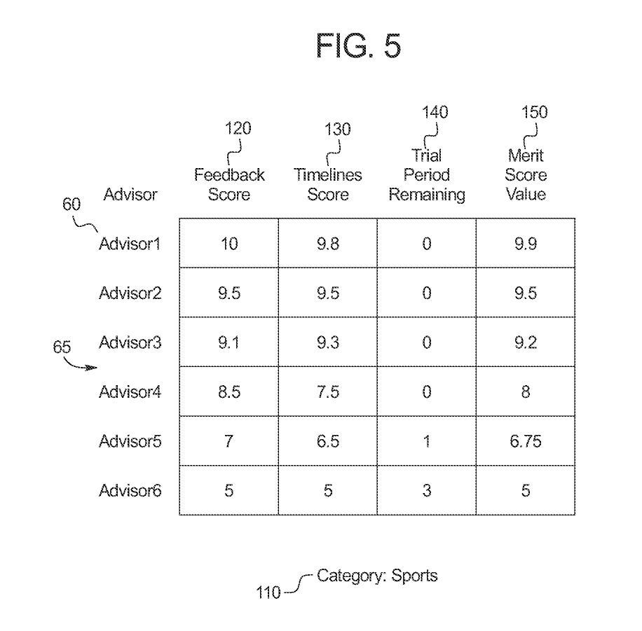

As shown in FIG. 5, the advisor list 115 drawn from a database 50 of advisor records 65 of available advisors 60. The database 50 may include a variety of factors that may be used to assemble a well-suited list of advisors 60. The database 50 may include factors that indicate a likelihood of an advisor 60 being able to answer a question competently and quickly. The database 50 may further include factors useful to provide advisors 60 a fair opportunity to be considered by questioners 30.

First, to choose advisors 60 knowledgeable in the subject of the question, one factor that may be used in assembling the advisor list 115 is a topic category 110 and/or sub-category 111. As described with reference to FIG. 3, the questioner 30 may select from a list of general categories 110 and/or sub-categories 111 or may be allowed to create their own category 110. The questioner 30 may select multiple categories 110 and/or sub-categories 111 to which the question pertains. In an embodiment, the advisors 60 in the question answering system 100 are listed as being knowledgeable in the categories 110 and sub-categories 111 of their choosing, and advisors 60 not listed in the categories 110 and/or sub-categories 111 of the question chosen may be excluded from the advisor list 115 for the question.

To encourage better answers, another factor that may be used in assembling the advisor list 115 is user feedback from questioners 30. As will be explained further below with regard to FIG. 6, after receiving an answer to a question, a questioner 30 may be presented with an opportunity to provide feedback 240. In the embodiment shown in FIG. 6, the questioner is asked to rate the answer 230. Feedback for an advisor 60 received from multiple questioners 30 may be aggregated into a feedback score 120 for the advisor 60. In an embodiment, the ratings received as feedback 240 may be used to determine a feedback score 120 that represents a ranking of the advisor 60 relative to other advisors 60.

The feedback score may take into account the total amount of feedback received to prevent advisors 60 having received a few strong ratings from outranking advisors 60 with a slightly lower average who have a longer history of excellent ratings. For example, if the advisors 60 are ranked on a ten point scale, an advisor 60 having an average of 9.0 with twenty ratings from questioners 30 may be given a higher feedback score 120, all else equal, than an advisor 60 having an average of 9.5 with only two ratings from questioners 30.

In some embodiments, feedback 240 may be multi-dimensional. For example, the question answering system 100 may ask for feedback 240 regarding the correctness of an answer 230, the level of useful detail in the answer 230, the questioner's satisfaction with the speed of receiving the answer 230, etc. It is contemplated that feedback 240 may include any appraisal of an advisor's activity in the question answering system 100, as will be understood by those skilled in the art from the examples provided herein.

An additional factor that may be used in determining an advisor list 115 may be a timeliness score 130 reflecting a history of the promptness of an advisor 60 in answering questions. For many questions, receiving an answer 230 quickly may be more important than being “correct.” For example, when looking for food, a questioner 30 might ask “Where are good places to eat in Champaign, Ill.?” For such a question, receiving a quick response may be crucial. The timeliness score 130 may be a measure of the average time an advisor 60 has previously taken to respond to a question presented to him or her. The timeliness score 130 may also be a ranking or rating that ranks an advisor 60 relative to all advisors 60 based on the average response time on questions presented to them. Even further, the timeliness score 130 may include information about the number of times an advisor 60 has failed to answer a question within a predetermined time limit. It is contemplated that the timeliness score 130 may include any information about the responsiveness of an advisor to a question, as will be understood by those skilled in the art from the examples provided herein. Further, when asking a question, a questioner 30 may indicate a preference for increased timeliness for questions that are very time dependent, or may indicate a reduced or lack of preference when timeliness is not important.

An even further factor that may be used in determining an advisor list 115 may be a measure of the recency of registration of the advisor 60 in the question answering system 100. Since recently registered advisors 60 have little user feedback 240, the feedback 240 they have received may be insufficient to calculate an accurate feedback score 120. Thus, to increase accuracy, the question answering system 100 may favor new advisors 60 by preferentially including new advisors 60 in the advisor list 115. For example, in a preferred embodiment, new advisors 60 may be displayed in the first three positions of the advisor list 115 during a trial period 140 for the new advisor 60. During the trial period 140, a new advisor 60 may be preferentially included in advisor list 115 for a set number of times, for example, five times, to permit new advisors 60 to develop a feedback score 120 and to encourage their participation in the question answering system 100 by being asked questions as soon as possible. In the preferred embodiment, after the trial period 140, new advisors 60 will be included in the advisor list 115 as elsewhere described herein. Alternatively, in other embodiments, advisors 60 that have a long duration of registration in the question answering system 100 may be favored since experienced advisor 60 in a category 110 are known to often provide useful answers 230 based on experience. When asking a question, a questioner 30 may be permitted to indicate a preference for advisors 60 that have a long duration of registration.

The factors described above may be aggregated into an overall rating 150 that may be used to select advisors 60 for inclusion in the advisor list 115. In an embodiment, an overall rating 150 may be used to compile the advisor list 115 by choosing the advisors 60 having the highest overall rating 150. In an alternative embodiment, the advisors 60 may be chosen probabilistically from the pool of advisors 60 in a manner that preferentially favors advisors 60 having higher overall ratings 150. An overall rating 150 may include further factors, for example, in embodiments where the questioner 30 is paying an advisor 60 for the advice, the advisor 60 may include a minimum payment, suggested payment, or otherwise competitively bid to answer questions in general or on a per-category basis.

Alternatively, the factors may be used to select advisors 60 for inclusion in the advisor list 115 on a quota basis. In an preferred embodiment, two of the advisors 60 are selected on a random basis out of the most recent one hundred advisors 60 to register, in the respective category 110; another two advisors 60 are selected on a random basis out of the database 50 of advisors 60 pertaining to the respective category 110; and the advisor 60 with the highest overall rating 150 is selected from the top of the merit list maintained for each category 110. In further embodiments, the questioner 30 may indicate preferences that may be used in determining the factors used to select advisors 60 for inclusion in the advisor list 115.

It is a goal of the question answering system 100 to be fair to advisors 60, and provide all advisors 60 the opportunity to answer questions. Therefore, while a high overall rating 150 may result in an advisor 60 being frequently included in advisor lists 115, the question answering system 100 may limit the frequency with which highly ranked advisors 60 are included in advisors list 115 to prevent lower-ranked advisors 60 from being excluded from advisor list 115.

As shown at step 205, after selecting advisors 60, the questioner 30 may input a question for answering. The questioner 30 may include any information or media useful to properly describe the question and may include images, video, files, or links along with the question.

As shown in step 206, a questioner 30 may be required to signup and pay before receiving an answer to his or her question. In the example shown, signup requests basic information such as login name, personal name, address, etc. Further, if the question answering system 100 requires payment, the questioner 30 may enter payment information. In a preferred embodiment, a questioner 30 may be permitted to ask a few initial questions for free.

After any required payment, the question may be sent to the advisor 60 selected. The advisor 60 may have a predetermined time limit, such as twenty-four hours, to answer the question. If the main advisor 60 does not answer, then the question is sent to one or more of any alternate advisors 60 selected, who may then also be required to answer in the predetermined time limit. If the alternate advisors 60 also do not answer in time, then the question may be sent to an advisor 60 selected by the question answering system 100. Further, any advisor 60 not answering in time may be penalized with a lower timeliness score 130. If the advisor 60 fails to answer a predetermined amount of questions, the advisor 60 may be suspended from the question answering system 100.

To answer the question, the question answering system 100 may contact the advisor 60 by any communications means, such as e-mail, or SMS text message. The advisor 60 may be required to reply within a predetermined time limit, such as twenty-four hours, or the question is then sent to another alternate advisor 60, who has also been selected from among the fixed list by the questioner 30. In addition, any advisor 60 who does not answer may be penalized with a lower timeliness score 130, as described above.

Turning to FIG. 6, at step 207, once an answer 230 has been received from an advisor 60, it is sent to the questioner 30. The questioner 30 is then prompted to provide feedback 240. In an embodiment, the answer 230 is forwarded to the questioner 30 via their email. The questioner 30 may then select a link to access a user interface 70 of the question answering system 100 to provide feedback 240. For example, the email may include a link asking the questioner 30 to rate his or her satisfaction on a scale of one to ten. If the questioner does not respond with feedback 240, then an average feedback 240 of five may be assumed and allotted to the advisor 60. As described, the feedback 240 may be used as a factor in determining whether to include the advisor 60 in future advisor lists 115. Further, as described, feedback 240 may be multi-dimensional and include dimensions such as: correctness of an answer 230, the level of useful detail in the answer 230, the user's satisfaction with the speed of the answer 230, etc.

To provide for questioner 30 having further questions, additional question answering screens may be provided where more specialized detailed and lengthier information can be exchanged between the questioner 30 and the advisor 60. The additional question answering screens may comprise a premium section, with premium pricing, and where the rules may be stricter. For example, in an embodiment of answering further questions, a rule may prevent any payment to the advisor 60 until and unless the questioner 30 reports that they are satisfied with the level of response.

Turning to steps 208-213 of the method 200 in FIG. 2, the steps of the method 200 trace the process of an advisor 60 registering and answering a question using the example question answering system 100. Starting at step 208, an advisor 60 may be presented with terms and conditions that the advisor 60 must accept to use the question answering system 100. The advisor 60 may further be shown an explanatory screen to explain the process of registering to answer questions, the process of being selected to answer a question, the process of answering a question, etc.

As shown in step 209, an advisor 60 may be prompted to enter personal information into the question answering system 100. Personal information may be used to contact an advisor 60, provide payment, etc. Further, personal information, such as demographic information, may be used by the question answering system 100 as a factor when selecting the list of advisors 60 for display to questioners 30. To maintain confidentiality, personal information may be withheld from other users of the question answering system 100. Further, any contact information provided may be used by the question answering system 100 to mediate the interaction between questioners 30 and the advisor 60 to further ensure confidentiality. For example, to maintain advisor 60 or questioner 30 confidentiality, direct contact between customer and advisor 60 may be restricted, such as by permitting interaction only through the question answering system 100 and withholding contact information. In embodiments where advisors 60 are paid for answering questions, advisors 60 may further be given the option of answering for free, or may be prompted to enter a minimum price for answering questions, or may otherwise be prompted regarding payment an advisor requires to answer a question.

Turning to step 210, the advisor 60 may be presented with instructions explaining how to market their question answering skills to questioners 30. The advisor 60 may be reminded that the questioner 30 selects him or her from an advisor list 115 and that the information requested in subsequent screens will be key to selling their skills to questioners 30.

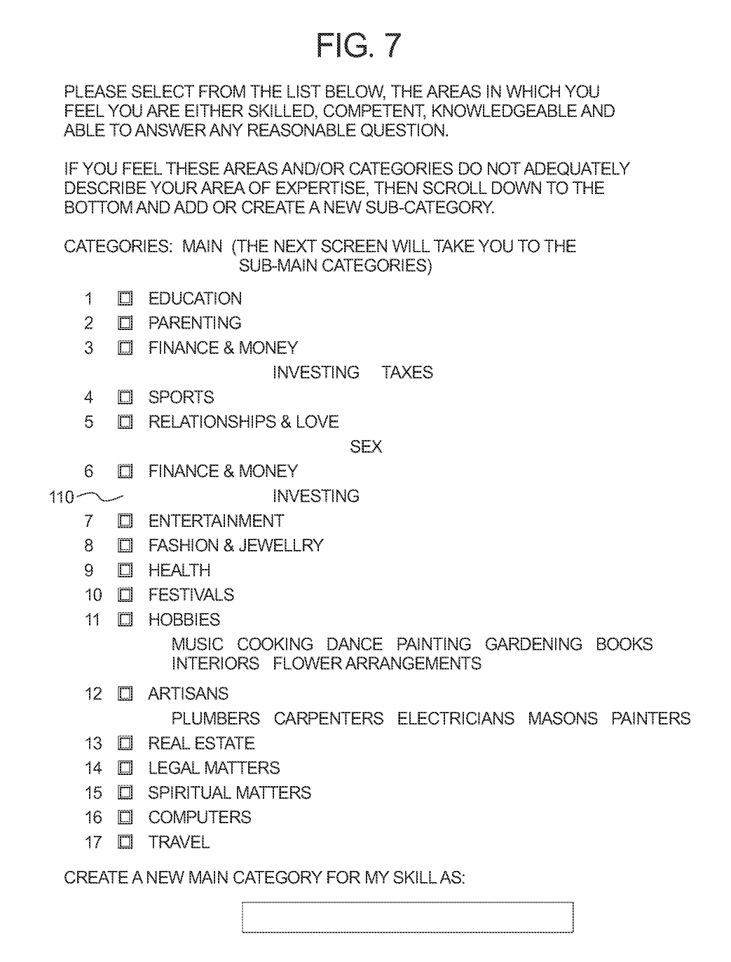

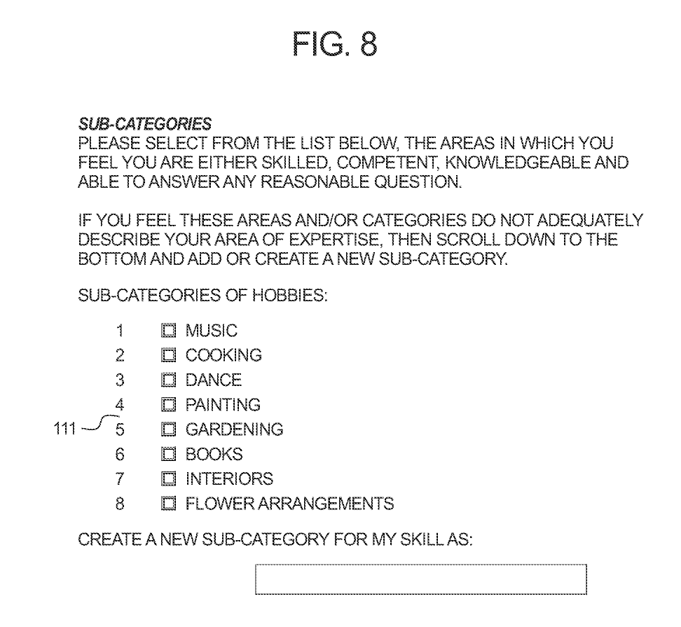

As shown in FIGS. 7 and 8, at step 211, the advisor 60 is prompted to enter areas of expertise on which the advisor 60 feels qualified to give advice. In the preferred embodiment shown, the areas of expertise may include categories 110 and subcategories 111 of subject matter. The advisor 60 may be permitted to select as many categories 110 and subcategories 111 as he or she feels competent to answer questions in. If the advisor 60 cannot find a desired category 110 or subcategory 111, the advisor 60 may be permitted to create a new category 110 or subcategory 111. Further, the advisor 60 may be permitted to update his or her areas of expertise at any time. By selecting a category 110 or subcategory 111 of expertise, an advisor 60 may be added to the pool of advisors 60 eligible to answer questions in that category 110 or subcategory 111 and may be displayed to questioners 30 in the advisor list 115.

At step 212, the advisor 60 may be prompted to provide a personal summary that will be displayed to questioners 30 to permit a questioner 30 to evaluate the advisor 60 when choosing an advisor 60 to answer a question. The advisor 60 may be prompted to give a relevant summary of his or her education, life experiences, skill sets, contacts, knowledge base, etc. The question answering system 100 may further provide advice to help advisors 60 market their skills or otherwise explain their qualifications. The advisor 60 may be asked to provide, or may be permitted to provide, any information that may be useful to a questioner 30 in choosing an advisor 60 as will be understood by those skilled in the art from the examples provided herein.

At step 213, after a questioner 30 has chosen an advisor 60, the advisor 60 may be contacted and directed to an answer form to answer the question. In an embodiment, the advisor 60 receives an email directing the advisor 60 to a question answering screen of the question answering system 100. In an alternate embodiment, an email address may be provided that the advisor 60 may use to respond to the question. In further embodiments, the advisor 60 may answer via SMS text message, etc. It is understood that the advisor 60 may be directed to respond to the question using any medium capable of receiving a written answer 230 as will be understood by those skilled in the art from the examples provided herein.

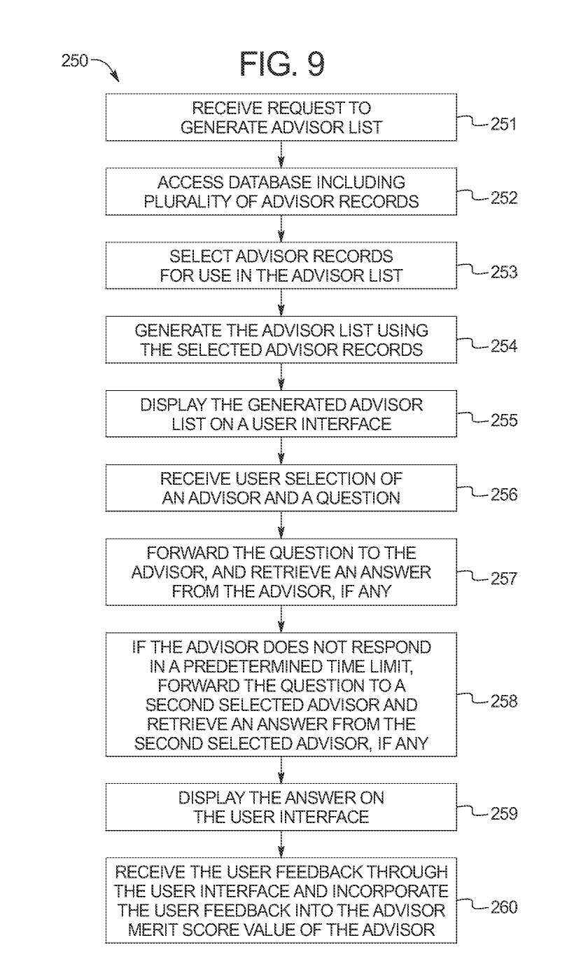

FIG. 9 illustrates an example of a method 250 performed by the question answering system 100. Starting at step 251, the controller 40 receives a request to generate an advisor list including a topic area value. The controller 40 may then proceed to step 252 and access a database 50 including a plurality of advisor records 65, wherein each advisor record 65 may include at least one topic area value, an advisor merit score value, and a recency of registration value.

Turning to step 253, the controller 40 may select advisor records from the database 50 to form an advisor list 115. In an embodiment, the selected advisor records 65 may include at least three of the advisor records 65. To promote accuracy of answers, at least one of the advisor records 65 may be a record selected based on advisor merit score values. To permit new advisors to develop an advisor merit score value, at least one of the advisor records 65 may be based on recency of registration values.

Proceeding to step 254, the controller 40 generates the advisor list using the selected advisor records 65. The advisor list 115 may be compiled into a web document for display by the user interface 70 at step 255. Through the user interface 70, at step 255, the controller 40 receives a user selection of an advisor 60 from the advisor list 115 and a question for the advisor 60 to answer.

Then, at step 257, the controller 40 forwards the question to the advisor 60, and retrieves an answer 230 from the user selected advisor 60, if any. If the user selected advisor 60 does not respond in a predetermined time limit, at step 258, the controller 40 forwards the question to a second selected advisor 60 and retrieves an answer 230 from the second selected advisor 60, if any. Step 258 may be repeated with further selected advisors 60 until an answer 230 is retrieved. After retrieving an answer 230, the answer 230 is displayed on the user interface 70 at step 259. The questioner 30 may be prompted to provide feedback at step 259, and at step 260, the controller 40 may receive the user feedback through the user interface 70 and incorporate the user feedback 240 into the advisor merit score value corresponding to a user selected advisor.

As described, a controller 40 controls aspects of the question answering system 100 described herein. The controller 40 may be embodied in one or more controllers 40 that may be adapted run a variety of application programs, access and store data, including accessing and storing data in the associated database 50 (which may be embodied in one or more databases 50), and enable one or more interactions with the other components of the question answering system 100. Typically, the one or more controllers 40 are embodied in one or more programmable data processing devices. The hardware elements, operating systems, and programming languages of such devices are conventional in nature, and it is presumed that those skilled in the art are adequately familiar therewith.

For example, the one or more controllers 40 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory 80, such as a dynamic random access memory (DRAM) and cache, as well as a read only memory 80, such as a PROM, EPROM, FLASH-EPROM, or the like. The system may also include any form of volatile or non-volatile memory 80. In operation, the main memory 80 stores at least portions of instructions for execution by the CPU and data for processing in accord with the executed instructions.

The one or more controllers 40 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 40 may further include appropriate input/output ports for interconnection with one or more output displays and one or more input mechanisms serving as one or more user interfaces 70 for the controller 40. For example, the one or more controllers 40 may include a graphics subsystem to drive the output display. The links of the peripherals to the system may be wired connections or use wireless communications.

Although summarized above as a PC-type implementation, those skilled in the art will recognize that the one or more controllers 40 also encompasses systems such as host computers, servers, workstations, network terminals, and the like. In fact, the use of the term controller 40 is intended to represent a broad category of components that are well known in the art.

Aspects of the systems and methods provided herein encompass hardware and software for controlling the relevant functions. Software may take the form of code or executable instructions for causing a controller 40 or other programmable equipment to perform the relevant steps, where the code or instructions are carried by or otherwise embodied in a medium readable by the controller 40 or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A system comprising:
a controller;
a memory coupled to the controller, wherein the memory is configured to store program instructions executable by the controller;
wherein in response to executing the program instructions, the controller is configured to:
in response to receiving a request to generate an advisor list, wherein the request includes a topic area value, access a database including a plurality of advisor records, wherein each advisor record includes at least one topic area value, an advisor merit score value, and a recency of registration value;
selecting advisor records for use in the advisor list, wherein the selected advisor records include at least three of the advisor records, including a first record selected based on advisor merit score values and a second record based on recency of registration values; and
generate the advisor list using the selected advisor records.

2. The system of claim 1 wherein the advisor merit score value is based on user feedback.

3. The system of claim 1 wherein the advisor merit score value is based on an advisor's average response time.

4. The system of claim 1 wherein the advisor merit score is based on an advisor's accuracy in answering questions.

5. The system of claim 1 wherein the controller is further configured to display the generated advisor list on a user interface.

6. The system of claim 5 wherein the controller is further configured to receive a user selection and a question through a user interface, wherein the user selection includes a user selected advisor from the advisor list.

7. The system of claim 6 wherein the controller is further configured to retrieve an answer from the user selected advisor and display the answer on the user interface.

8. The system of claim 6 wherein the user selection includes a first user selected advisor and a second user selected advisor from the generated advisor list, wherein if the time between delivering the question to the first selected advisor and receiving the answer from the first selected advisor exceeds a predetermined time limit, the controller is configured to send the question to the second selected advisor.

9. The system of claim 1 wherein the controller is configured to receive user feedback through a user interface and incorporate the user feedback into the advisor merit score value corresponding to a user selected advisor.

10. A system comprising:
a controller;
a memory coupled to the controller, wherein the memory is configured to store program instructions executable by the controller;
wherein in response to executing the program instructions, the controller is configured to:
in response to receiving a request to generate an advisor list, wherein the request includes a topic area value, access a database including a plurality of advisor records, wherein each advisor record includes at least one topic area value, an advisor merit score value, and a recency of registration value;
selecting advisor records for use in the advisor list, wherein the selected advisor records include at least five of the advisor records, including a first record selected based on advisor merit score values, two records selected based on recency of registration values, and two records selected at random; and
generate the advisor list using the selected advisor records.

11. The system of claim 10 wherein the two records selected based on recency of registration values are selected at random from the 100 most recently registered advisor records with a topic area value that matches the topic area value of the request.

12. The system of claim 10 wherein the two records selected at random are selected from the advisor records with a topic area value that matches the topic area value of the request.
